(19) United States
(12) Patent Application Publication
(10) Pub. No.: US 2008/0250316 A1
(43) Pub. Date: Oct. 9, 2008

(54) MECHANISM TO IMPROVE A USER'S INTERACTION WITH A COMPUTER SYSTEM

(75) Inventors: Rui Zhang, Beijing (CN); Envi Chen, Beijing (CN); Yujun Zhang, Beijing (CN); John Hajdukiewicz, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/696,313

(22) Filed: Apr. 4, 2007

(51) Int. Cl. G06F 3/00; G06F 9/46

(52) U.S. Cl. 715/708; 718/100

(57) ABSTRACT

An approach for improving a user's interaction with computer system which may include building a context aware user interface by extending a concur task tree (CTT). Although a task model approach may work well in the design time, it does not appear to take consideration of contextual information at runtime. To overcome this limitation, an approach may be used to apply contextual information to the task at runtime. The approach may introduce task activation criteria based on contextual information and apply contextual information to optimize interaction quality.

### BACKGROUND

The present invention pertains to computing systems and particularly to user interfaces of such systems. More particularly, it pertains to user interface improvements.

### SUMMARY OF INVENTION

The invention is an extended concur task tree providing contextual information for a user interface during run-time of a computer.

### BRIEF DESCRIPTION OF THE DRAWINGS

FIG. 1 is a diagram of an overview framework of the present system;

FIG. 2 is a diagram of a flow for task execution;

FIG. 3 is a diagram of the task of the location aware guide;

FIG. 4 is a diagram of the task of the role aware access;

FIG. 5 is a diagram of a model-based solution;

FIG. 6 is a legend of common symbols;

FIG. 7 is a diagram of a layout of the various models of a model-based solution;

FIG. 8 is a diagram of an overview of a modeling approach;

FIG. 9 is a diagram of a model compiler;

FIG. 10 shows a legend of symbols representing various tasks;

FIG. 11 is a diagram of a priority tree of tasks relating to a cell phone;

FIG. 12 is a diagram of a concur task tree;

FIG. 13 is a diagram of an extended concur task tree;

FIG. 14 is a concur task tree class diagram related to a cell phone operation;

FIG. 15 is a table of interactive functions with examples;

FIG. 16 is an abstract interaction object block diagram;

FIG. 17 a concrete interaction object block diagram; and

FIG. 18 is a diagram of an abstract user interface generation algorithmic mechanism.

### DESCRIPTION

There may be a number of approaches to build context aware UIs (user interfaces). One approach may generate multiple interfaces for different contexts of use starting from one task model. In contrast with that approach, the present invention does not focus on the design aspect as much as such approach, but the invention may emphasize the run-time framework necessary for accomplishing this. Another approach may provide designers and developers with various automatic support of development of nomadic applications on a variety of devices by some abstractions and transformations. But those transformations must be manually dealt within design time. Still another approach may define a plastic user interface with the capability of adapting to different contexts of use while preserving usability. To process context at runtime, it may introduce an adaptive process, which allows creating user interfaces for the running systems according to different contextual information. Although at several stages in the user interface design process (task specification, abstract user interface, concrete user interface, runtime environment), a translation may take place between two systems. The designer may have to change the task specification manually in the process if the context has an influence on the tasks that can be performed. Another approach may define a specification language and communication protocol to automatically generate user interfaces for remotely controlled appliances. Such language may describe the functionalities of the target appliance and contain enough information to render the user interface. In this case, the context may be secured by the target appliance represented by its definition.

Due to the rapid development of information technology, one may be increasingly surrounded by various devices with the capability of computation and communication in the present living or working environment. Computing seems to have become rather pervasive in such an environment. This trend may engender new requirements for various computing entities such as the ability of user interfaces to adapt to different contexts of use. A context of use may be defined as a set of values of variables that characterizes a computational device used for interacting with a system as well as the physical and social environment where the interaction takes place.

A model based approach may be used to automate the rendering a user interface for different contexts. Of the relevant models, task models may play a particularly important role because they indicate the logical activities that an application should support. A task may be an activity that should be performed in order to reach a goal. A goal is either a desired modification of state or an inquiry to obtain information on current state.

Although a task model approach may work well in the design time, it does not take consideration of contextual information at runtime. To overcome this limitation, one may introduce an approach to apply contextual information to the task at runtime. The approach may have two contributions. The first one is to introduce task activation criteria based on contextual information, and the other is to apply contextual information to optimize interaction quality.

Several points that may be improved include task activation criteria based on contextual information introduced into the present extended concur task tree (ConcurTaskTree) to provide context awareness support in a dynamic situation, and use contextual information to optimize interaction quality. These two points may lead the solving on the issues which the user roles and context are static for the task models. The dynamic and context awareness may be introduced to enhance the task models for any adaptive user interface application.

A task model may become the glue between the functional core of an application and the actual user interface. LOTOS [ISO, IS8807] may be an example of notation which may be used in formal specifications. The concur task tree (CTT), derived from this notation, may be a graphical and very intuitive notation for specifying a task model. Its main purpose is to be an easy-to-use notation, which may support the design of real industrial applications. The CTT task model may be based on several major points. First, the user action oriented approach may be based on hierarchical structure of tasks represented by a tree-like structure. Second, it may require identification of temporal relations, by LOTOS, among tasks at the same level. Third, it may allow the identification of the objects associated to each task and of the actions which allow them to communicate with each other.

In addition, CTT may include several categories of tasks depending on the allocation of their performance, which include user, application, interaction and abstract tasks. User tasks may be performed entirely by the user. They require cognitive or physical activities without interacting with the system. An instance may be deciding what to do, or reading the information presented on a display.

Application tasks may be completely executed by the system. The tasks can receive information from the system and supply information to the user. An example may be processing information from a previously executed interaction task, and presenting the results to the user. Interaction tasks may be performed by user interactions within the system. An example of these may be filling in a form.

Abstract tasks may be complex tasks on an abstract level so that they can not be assigned to any of the three previous cases. An abstract task usually has descendants of different types of tasks; for example, a task that requires user interaction as well as application feedback.

Although one may adopt CTT to represent application's behavior and adopt a TERESA (Transformation Environment for inteRactivE Systems representations) tool to transform a UI for different platform, this “one model, many interface” mechanism may be only suitable for the design time. It does not necessarily take consideration of contextual information at runtime. However, contextual information may play an important role to improve user's interaction with computer, especially in a ubiquitous computing environment, where many devices and applications, automatically adapted to changes in their surrounding physical and electronic environment, can lead to enhancement of the user experience. To overcome this limitation, one may introduce an approach to apply contextual information to the task at runtime.

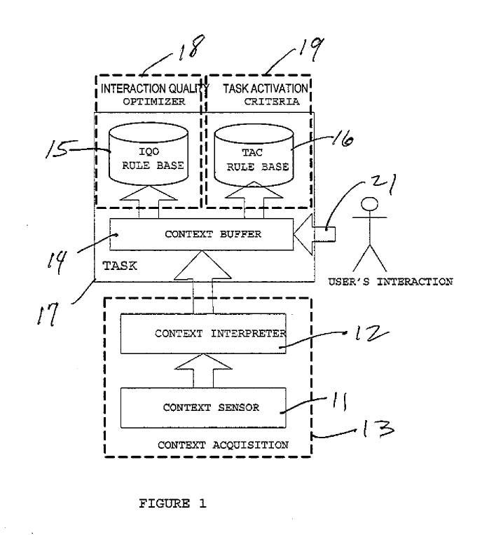

The invention relates to an approach to improve a user's interaction with computer system which may include building a context aware user interface by extending a concur task tree (CTT). FIG. 1 is a diagram of an overview framework. The Figure shows an application of contextual information to a task. A context sensor 11 may provide an output to a context interpreter 12. The context sensor 11 and interpreter 12 may be at least a part of a context acquisition module 13. An output of the context interpreter 12 may go to a content buffer 14. A user's interaction 21 may be input to the content buffer 14. The content buffer 14 may provide an output to an IQO (interaction quality optimizer) rule base 15 and an output to a TAC (task activation criteria) rule base 16. The context buffer 14, the IQO rule base 15 and the TAC rule base 16 may be at least a part of a task module 17. The task of module 17 may be an application or an interaction task. The IQO rule base 15 may be at least a part of an interaction quality optimizer 18. The TAC rule base 16 may be at least a part of a task activation criteria module 19.

Because the “user tasks” may include a user's cognitive or physical activities without interacting with the system and the “abstract tasks” may be refined to a concrete task, just two types of tasks should be considered in the present approach. In FIG. 1, the “task” may mean “application task” or “interaction task”. One major amendment may be to add two rule bases to it when a task is defined. While a task is executed, the contextual information, acquired from environment, may be put into the context buffer 14. How to get context is discussed herein relative to “context acquisition”. The context obtained from environment and/or the information inputted by user may be asserted (inserted) into the TAC (task activation criteria) rule base 16 in order to judge if the task can be activated. When a task is activated, the present approach may assert (insert) the content of context buffer into IQO (interaction quality optimizer) rule base 15 to improve user interface to enhance the user experience.

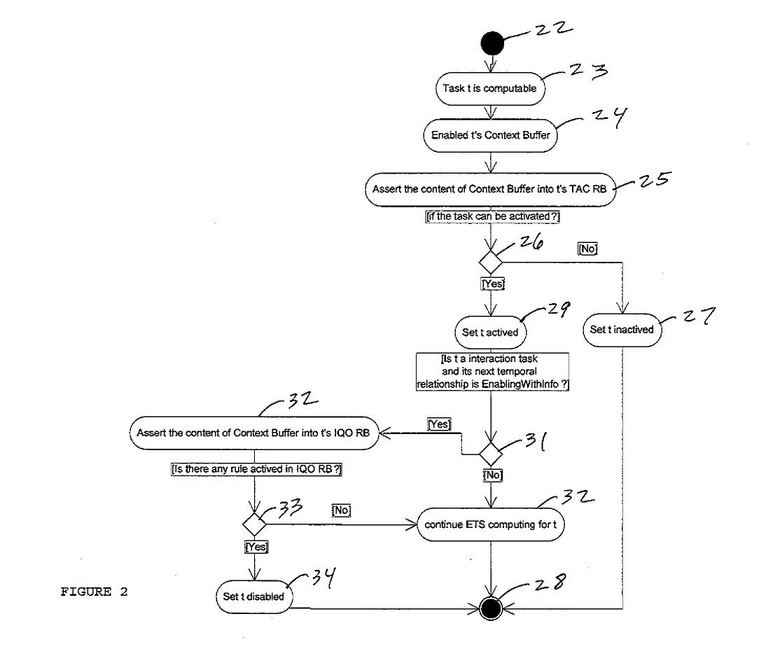

FIG. 2 shows a flow of task execution. The flow of task execution may begin at a starting point 22 where a task “t” is input to a block 23 where task t is deemed computable. Then the output of block 23 may go to an “enabled t's context buffer 14” block 24. The output of block 24 may go a block 25 for an “assert the content of content buffer 14 into t's TAC RB 16”. The output of block 25 may go to a decision symbol 26 which asks whether the task can be activated. If the answer is no, then a block 27 shows “set t inactivated” and the approach is terminated at end place 28.

If the decision of symbol 26 is yes, then a block 29 shows “set t activated”. The output of block 29 may go to a decision symbol 31 which asks whether “t is an interaction task and its next temporal relationship is enabling without information (EnablingWithInfo)”. If the answer is no, then the answer may lead to block 32 which indicates “continue ETS computing for t” and after block 32, the approach is terminated at end place 28. If the answer at symbol 31 is yes, the answer may lead to block 32, which indicates “assert the content of context buffer 14 into t's IQO RB 15”. An output from block 32 may go to a decision symbol 33 which asks the question whether there is any rule activated in IQO RB 15. If the answer is no, then the answer may lead to block 32 which indicates “continue ETS computing for t”. After block 32 the approach may be terminated at end place 28. If the answer is yes, then the output may go to block 34, which indicates “set t disabled”, and be terminated at end place 28.

One contribution of the invention may be to introduce task activation criteria based on contextual information, and another contribution may be to apply contextual information to optimize interaction quality.

A unified interaction task may be noted. In CTT, interaction tasks may be performed just by user interactions. Different from the present definition, the concept may be extended to considering environment interaction (such as wired or wireless network information, location, time, and so forth). From a data flow perspective, both the end user and the environment could input data/information into the system. But the environment could do this automatically, and the environment may do it without any user interface. In a present extended task engine, one does not necessarily distinguish the sender of an interaction, for the result of both user interaction and environment interaction may update the context buffer. Before activating an interaction task, one may check the context buffer. If one finds a related context object, then one may draw a conclusion that the interaction task has been done by the environment. Then one may skip the activation for the interaction task. One may also skip the UI generation for the interaction task.

Task activation criteria may be based on contextual information. Different tasks have different criteria to activate. It may be difficult to define a uniform activation criterion. When a task is defined, the developer should give some activation rules. At runtime, the contextual information related to those rules may be queried or notified. According to those rules and contextual information, a task may be evaluated to be activated or inactivated. For example, there may be an “application task” which may only display a secret document for the manager or the employee authorized by manager. When the developer defines the task, the developer may add the rules to TAC (task activation criteria) rule base (RB) 16 like the following.

### Criteria 1:

Condition: Context.User.Role=“Manager”

### Criteria 2:

Condition: Context.User.Authorized=True

When the task is executed, it may query the information of current user instance. Only when its condition is satisfied, the task may be activated.

An interaction quality optimizer 18 may be based on contextual information. According to CTT's definition, the contextual information can not be adopted by the task. However, contextual information may be adopted to improve the UI's quality. The present approach may redefine CTT. So when a user interacts with system, context may also be an important element. When a task is defined, the developer needs to provide some rules about the UI's generation.

A combination context with the task may lead to an enhancement of the user's experience. An example may be to display states of damaged devices on site. If there is an adoption of the CTT's approach, the user needs to manually select his current location and damaged devices. And worse is that it may be difficult for the user to determine which device is damaged. However, if one adopts the present approach, then the developer may define the following rule.

### Optimizer Rule: a User, a Site, and a Device

Condition1: Context.User.Location=Context.Site

Condition2: Context.Device.Containedby=Context.Site

Condition3: Context.Device.Damaged=True

When a task is executed, the task may query the states of current user, site and device to judge if the condition is satisfied. For the above condition 1, the present approach may be processed like the following.

Define a site: site.location=<x, y, z>
site.length=nLength
site.width=nWidth
site.height=nHeight
   One may get a user's location from a sensor.
User.location=<x′, y′, z′>
   The next job is to judge if <x′, y′, z′> is a point of cube defined by the above site.

One may note context acquisition. Contextual information may play an important role in a context aware application. Context acquisition may be the premise of the use of context in the application. Context-aware applications need to take advantage of the sensors and sensing techniques available to acquire the contextual information. One may look at two situations in which context is handled, that is, connecting sensor drivers directly into applications and using servers to hide sensor details.

In the first situation, application designers may be forced to write code that deals with the sensor details, using whatever protocol the sensors dictate. There may be several issues with this approach. The first issue may be that the approach makes the task of building a context-aware application very burdensome by requiring application builders to deal with the potentially complex acquisition of context. The second issue is that approach does not support good software engineering practices. The approach does not necessarily enforce separation between application semantics and the low-level details of context acquisition from individual sensors. This may lead to a loss of generality, making the sensors difficult to reuse in other applications and difficult to use simultaneously in multiple applications.

Ideally, one would like to handle context in the same manner as one handles user input. By separating how context is acquired from how it is used, applications may now use contextual information without concern about the details of a sensor and how to acquire context from it. One may designate a server to support context event management either through the use of a querying mechanism, a notification mechanism, or both to acquire context from sensors. A querying mechanism may be appropriate for one-time context needs. Once an application receives the context, it needs to then determine whether the context has changed and whether resultant changes are interesting or useful to it. The notification or publish/subscribe mechanism may be appropriate for repetitive context needs, where an application may want to set conditions on when the application wants to be notified.

Due to focuses on the use of context in applications instead of the context acquisition, how to acquire the contextual information appears out range of the present invention. But the developers can refer to the following context infrastructures in Dey's Context Toolkit at Georgia Institute of Technology, Hong's Context Fabric at UC Berkeley, Jonsson's Context Shadow at KTH, Judd's CIS (Context Information Server) at CMU, and so on. The developer also may refer to the Me-Centric Domain Server at HP, or CoBrA (Context Broker Architecture) at UMBC.

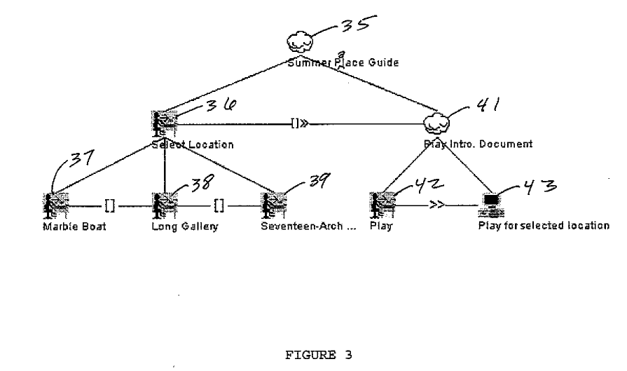

Implementation may be noted. One may now demonstrate how the present approach is used to build applications. How the location aware guide and role aware access can be built may be described. One scenario may be a location aware guide. For instance, when one visits a large royal park, e.g., Summer Palace, one may be given a hand held device, such as PDA. So whichever scenic spot one visits, one may get its introduction information by just clicking the “Play” button on the PDA. FIG. 3 is a diagram of the task of the location aware guide. The Summer Palace guide may be represented with symbol 35. From guide 35, one may select a location at symbol 36 and then select one of the locations, following symbol 36, which may include marine boat 37, long gallery 38, seventeen arches 39, and possibly other locations. The symbol [ ] between these locations may be a temporal operator indicating choice. After the selection, one may go to symbol 41 for playing the introductory document which may be effected at a play symbol 42 for playing the selected document at symbol 43. The temporal operator [ ]>> between symbols 36 and 41 may indicate enabling (perhaps with information). The temporal operator >> between symbols 42 and 43 may indicate enabling.

For an instance relating to FIG. 3, the original enabled tasks may be of item 36, task “Select Location” and its subtasks. But with an extended CTT system, if there is environment information that can provide selection support, then one need not generate a UI for these tasks. The selection may be completed by a computer system internally. Then the original enabled tasks may be soon disabled. Instead, the item 41, task “play Intro Document”, may be enabled. This may be or lead to the optimized tasks.

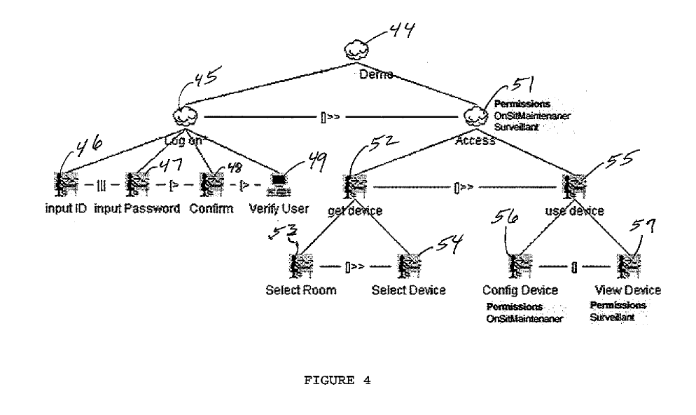

Another scenario may be the role aware access. Different task access permissions could be assigned to each task. According to this information, some tasks may be disabled for some role. As the result, a different user may get a different user interface. FIG. 4 is a diagram of the task of the role aware access. In the scenario of FIG. 4, a surveillant is not necessarily able to get the user interface of “Config Device”. One or the surveillant may begin at a demo symbol 44 indicated in FIG. 4. Then one may go to symbol 45 to log on. From there, one may input identification (ID) at symbol 46, input password at symbol 47, confirm at symbol 48 and the user may be verified at symbol 49 of the approach. The temporal operator ||| between symbols 46 and 47 may indicate concurring. The temporal operator [> between symbols 47 and 48, and between symbols 48 and 49, may indicate disabling.

Then one may go to the “Permissions OnSitMaintenaner Surveillant” represent by symbol 51 for access. One may get a device at symbol 52, select room at symbol 53 and select device at symbol 54. The temporal operator [ ]>> between symbols 53 and 54 may indicate enabling or enabling with information exchange. Then one may go to use the device at symbol 55. The temporal operator between symbols 52 and 55 may be the same as that between symbols 53 and 54. If one is to configure the device at symbol 56, then “Permissions OnSitMaintenaner” would be needed. If one is to go to view the device at symbol 57, then “Permissions Surveillant” would be needed. The temporal operator [ ] between symbols 56 and 57 may indicate choice.

By involving context information in task computation, one may optimize current enabled task set according to current interaction context. This may provide a foundation for the high efficient user interface generation. Introducing a rule-based approach for task activation criterion may bring a flexible mechanism for context adaptation configuration.

The following is about a model-based solution for a system which may be referred to as a system. The system may have goals, a model-based solution, a modeling approach, a task model, UI generation, and issues and future directions.

Goals may include situation-aware, adaptive UI, platform-independence, a system and components update at run-time, FR application deployment, and a wireless handheld device used in wireless LAN and WSN environment. There may be a context-aware UI. The context may include those of a user, environment and platform. The context-aware UI (situation-aware and platform-independent) may involve intelligent UI which is adaptive for a user and environment, and pervasive UI which is adaptive for the platform.

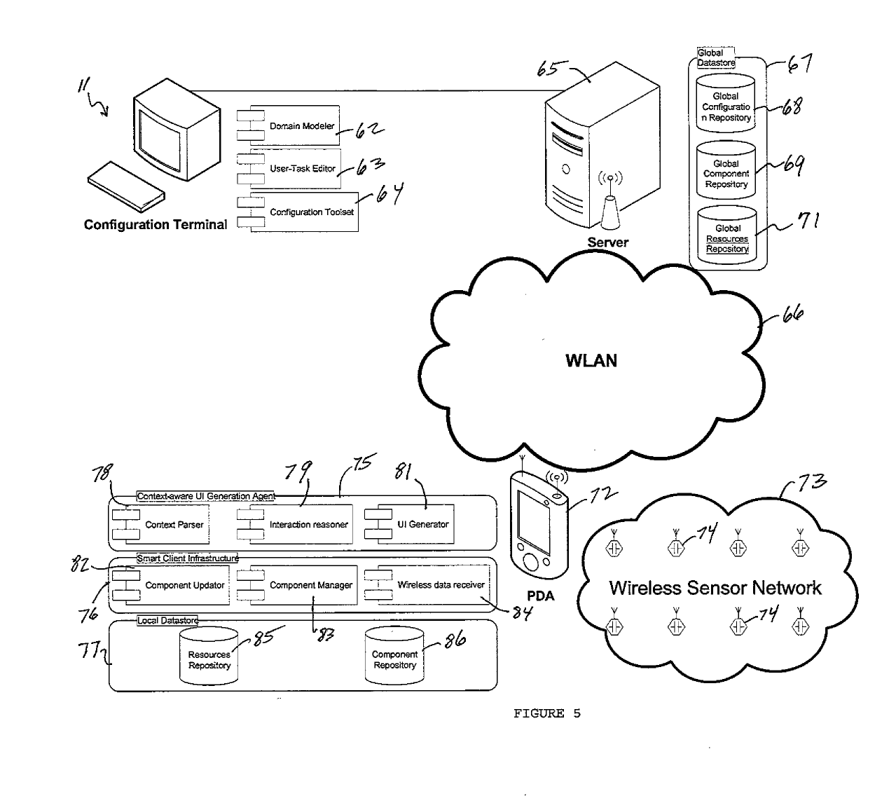

FIG. 5 is a diagram of a model-based solution. One may begin at a configuration terminal 61 although one could begin at another place. Terminal 61 may have a computer and keyboard. The terminal may have a domain modeler 62, a user-task editor 63 and a configuration toolset 64. Terminal 61 may be connected to a server 65 which may be connected to a WLAN 66. Server 65 may have a global datastore 67. Datastore 67 may have a global configuration repository 68, a global component repository 69 and a global resources repository 71. A personal digital assistant (PDA) 72 may be connected to the WLAN 66. There also may be a wireless sensor network 73 having numerous sensors 74. Network may be connected to the WLAN 66. Various components may interact with each other via the WLAN 66. The PDA 72 may have or be associated with a context-aware UI generator agent 75, a smart client infrastructure 76 and a local datastore 77. The context-aware UI generator agent 75 may have a context parser 78, an interaction reasoner 79 and a UI generator 81. The smart client infrastructure 76 may have a component updator 82, a component manager 83 and a wireless data receiver 84. The local datastore 77 may have a resources repository 85 and a component repository 86.

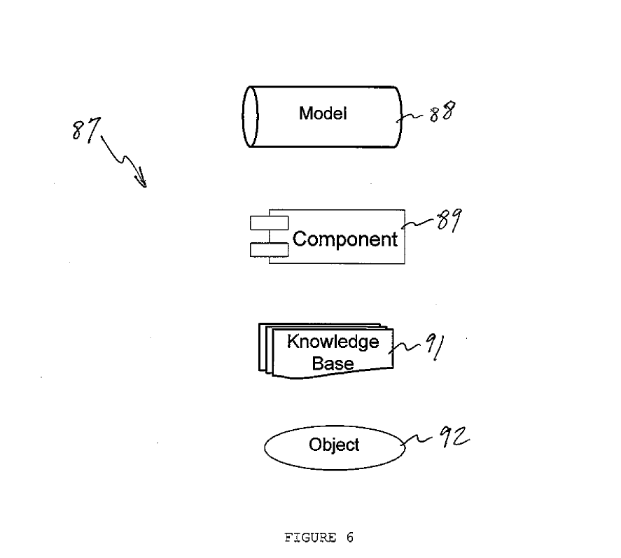

FIG. 6 is a legend 87 showing a symbol 88 for a model, a symbol 89 for a component, a symbol 91 for a knowledge base, and a symbol 92 for an object 92. Legend 87 may be applicable to various diagrams of the Figures described herein.

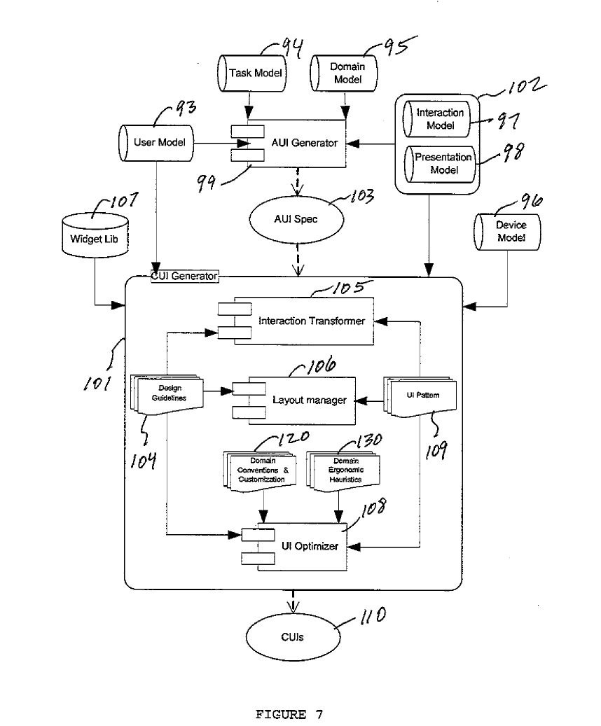

FIG. 7 is a diagram of a layout of the various models of a model-based solution. The solution may include a user model 93, a task model 94, a domain model 95, a device model 96, an interaction model 97 and a presentation model 98. The user model 93 may have an output to an AUI (abstract user interface) generator 99 and a CUI (concrete user interface) generator 101. The task model 94 may have an output to the AUI generator 99. The domain model may have an output to the AUI generator 99. The device model 96 may have an output to the CUI generator 101. Interaction model 97 and presentation model 98 may constitute a module 102. Module 102 may have an output to the AUI generator 99 and an output to the CUI generator 101. A widget library 107 may have an output to CUI generator 101. The AUI generator 99 may have an output of AUIs that go an AUI spec object 103. An output of object 103 may go to the CUI generator 101. Generator 101 may have a design guidelines knowledge base having an output to an interaction transformer 105, an output to a layout manager 106 and an output to a UI optimizer 108. A UI pattern knowledge base 109 may have an output to interaction transformer 105, an output to the layout manager 106 and an output to a UI optimizer 108. A domain conventions and customization knowledge base 120 may provide an output to UI optimizer 108. A domain ergonomic heuristics knowledge base 130 may provide an output to UI optimizer 108. The CUI generator 101 may output CUIs as object 110.

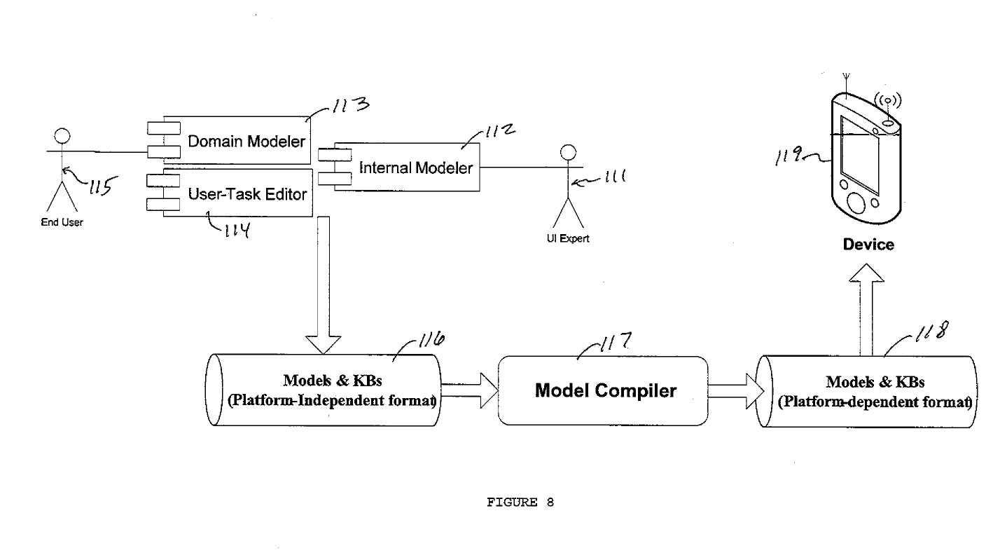

FIG. 8 is a diagram of an overview of a modeling approach. A UI expert 111 may provide input to an internal modeler 112. An end user 115 may provide input to a domain modeler 113 and a user-task editor 114. Internal modeler 112, domain modeler 113 and user-task editor 114 may interact and provide an output of models and KBs of a platform-independent format to module 116. At least some of these models and KBs may go to a model compiler 117. Models and KBs may go as an output to module 118. At module 118, the models and KBs may have a platform-dependent format. An output from module 118, which may include models and KBs, may go to a device 119. Device 119 may be a PDA or other suitable mechanism. Device 119 may be wireless but not necessarily so. Device may have one or more sensors.

A modeling language may involve a “model” and the modeling approach. OWL-DL may be used as a model exchange representation. The OWL (web ontology language) is designed for use by applications that need to process the content of information instead of just presenting information to humans. OWL appears to facilitate greater machine interpretability of web content than that supported by XML, RDF, and RDF Schema (RDF-S) by providing additional vocabulary along with a formal semantics. OWL has three increasingly-expressive sublanguages—OWL Lite, OWL DL, and OWL Full. The web ontology language has been an Official World Wide Web Consortium (W3C) standard since February 2004. It is based on predecessors such as (DAML+OIL). OWL-DL is the subset of OWL-Full that is optimized for reasoning and knowledge modeling. OWL DL is an ontology language based on logic (viz., description logic). Description logic may be considered the most important knowledge representation formalism unifying and giving a logical basis to the well known traditions of frame-based systems, semantic networks and KL-ONE-like languages, object-oriented representations, semantic data models, and type systems.

OWL DL is a platform-independent extensible Language based on RDF(S) (resource description framework-scheme). The RDF may integrate a variety of applications from library catalogs and world-wide directories to syndication and aggregation of news, software, and content to personal collections of music, photos, and events using XML as an interchange syntax. The RDF specifications may provide a lightweight ontology system to support the exchange of knowledge on the web.

SWRL FOL may be used as a “knowledge base” exchange representation. It may be a semantic web rule language (SWRL) first order logic (FOL) language. SWRL may be a semantic web rule language combining OWL and RuleML. It has been a member submission by W3C since May 2004. It may be based on a combination of the OWL and RuleML. A rule markup initiative has taken steps towards defining a shared rule markup language (RuleML), permitting both forward (bottom-up) and backward (top-down) rules in XML for deduction, rewriting, and further inferential-transformational tasks. SWRL-FOL may be based on RDF/XML. The resource description framework (RDF) may integrate a variety of applications from library catalogs and world-wide directories to syndication and aggregation of news, software, and content to personal collections of music, photos, and events using XML as an interchange syntax. The RDF specifications may provide a lightweight ontology system to support the exchange of knowledge on the Web. The extensible markup language (XML) may be a simple, very flexible text format derived from SGML (ISO 8879). Originally designed to meet the challenges of large-scale electronic publishing, XML may also play an increasingly important role in the exchange of a wide variety of data on the web and elsewhere. SWRL-FOL may be a rule language based on first order logic.

The modeling approach may use modeling and reasoning tools (i.e., a component). A Protégé OWL Plugin may be used as a modeling tool (for both OWL and SWRL). The Protégé-OWL editor is an extension of Protégé that supports the web ontology language (OWL). OWL is a very recent development in standard ontology languages, endorsed by the World Wide Web Consortium (W3C) to promote the semantic web vision.

A modeling tool should be built for the present system if it is necessary. Leverage may be made to the existing OWL Reasoner at modeling-time, such as Racer which is integrated with Protégé. RACER, or RacerPro as it subsequently is called, was an early OWL Reasoner on the market. These appeared in 2002 and have been continuously improved. While others have tried hard to achieve comparable speed, RacerPro appears to be one of the fastest OWL reasoning systems available. Many users have contributed to the stability that the Reasoner currently demonstrates in many application projects around the world.

With the exception of nominals, which appear difficult to optimize, RacerPro may support the full OWL standard (indeed, nominals may be supported with an approximation). Protege may support an extended version of OWL (namely OWL with qualified cardinality restrictions) that is already supported by RacerPro with certain algorithms and optimization techniques.

Protégé is generally a free, open source ontology editor and knowledge-base framework. The Protégé platform may support several main ways of modeling ontologies via the Protégé-Frames and Protégé-OWL editors. Protégé ontologies can be exported into a variety of formats including RDF(S), OWL, and XML Schema. Protégé may be based on Java, be extensible and provide a plug-and-play environment that makes it a flexible base for rapid prototyping and application development.

A Reasoner may be used at run-time and may be ported from Rule Engine of BRF (business rule framework). It may be fit for an embedded computation environment and be support for DL ABox reasoning. It may be built upon a reasoning result of the OWL Reasoner.

The modeling approach may also include a “model compiler” and KB compiling. The model compiler may be leveraged to XML/XSLT technology. The model and KB compiling may be converted from an exchange format to a platform-dependent format. The compiler may be optimized for an embedded platform.

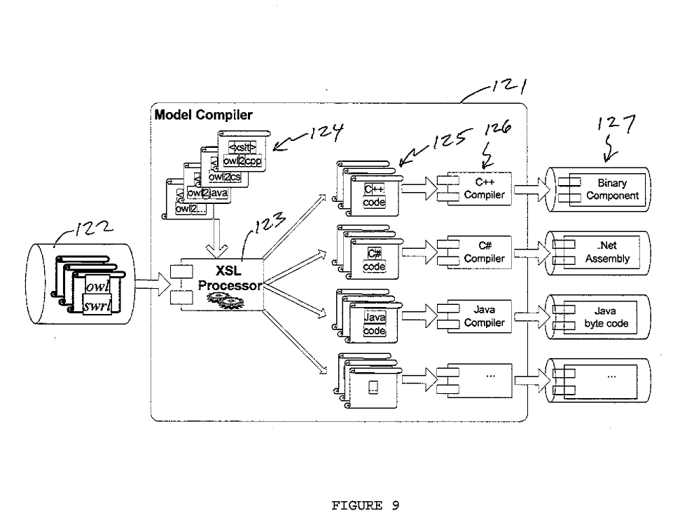

FIG. 9 is a diagram of a model compiler 121. A module 122 may have OWL and SWRL language outputs to an XSL processor 123 in the model compiler 121. In compiler 121, <xsit> OWL2ccp, OWL2cs, OWL2java, and so on, information 124 may be input to processor 123. Outputs of processor 123 may include information 125 in terms of C++ code, C# code, Java code, and so forth, which in turn may go to compilers 126 for C++, C#, Java, and so forth, respectively. Outputs 127 from compilers 126, respectively, may include binary components, net assembly, java byte code, and so forth, respectively.

One may note the syntax and semantics, as defined by the present specification, of XSLT (XSL transformations), which is a language for transforming XML documents into other XML documents. XSLT may be designed for use as part of XSL, which is a stylesheet language for XML. In addition to XSLT, XSL may include an XML vocabulary for specifying formatting. XSL may specify the styling of an XML document by using XSLT to describe how the document is transformed into another XML document that uses the formatting vocabulary. XSLT may also be designed to be used independently of XSL. However, XSLT is not necessarily intended as a completely general-purpose XML transformation language. Rather it may be designed primarily for the kinds of transformations that are needed when XSLT is used as part of XSL.

ConcurTaskTree may be used as a task model. ConcurTaskTree may be a notation for task model specifications (apparently developed at least in part by another) to overcome limitations of notations previously used to design interactive applications. Its main purpose is to be an easy-to-use notation that can support the design of real industrial applications, which usually means applications with medium-large dimensions.

ConcurTaskTree used as a task model may have features including hierarchical structure, graphical syntax, concurrent notation, expressive and flexible notation, compact, understandable representation, and widely used in related works.

The features of a concur task tree (ConcurTaskTree) may be more specifically noted. A hierarchical structure may be something very intuitive. In fact, often when people have to solve a problem, they tend often to decompose it into smaller problems, while still maintaining the relationships among the smaller parts of the solution. The hierarchical structure of this specification may have two advantages. It may provide a large range of granularity allowing large and small task structures to be reused, and it may enable reusable task structures to be defined at both a low and a high semantic level.

A graphical syntax often (not always) may be easier to interpret. In this case, it should reflect a logical structure and so it should have a tree-like form.

Concurrent notation may include operators for temporal ordering which are used to link subtasks at the same abstraction level. This sort of aspect is usually implicit, but expressed informally in the outputs of a task analysis. Having the analyst use these operators is a substantial change to normal practice. The reason for this innovation is that after an informal task analysis, one may want designers to express clearly the logical temporal relationships. A reason for this is because such ordering should be taken into account in the user interface implementation to allow the user to perform at any time the tasks that should be active from a semantic point of view.

A focus on activities may allow designers to concentrate on the most relevant aspects when designing interactive applications that encompass both user and system-related aspects avoiding low level implementation details which at the design stage would only obscure the decisions to take.

This notation may show two positive results. One is an expressive and flexible notation able to represent concurrent and interactive activities, and also have the possibility to support cooperation among multiple users and possible interruptions. The other is a compact, understandable representation. A key aspect in the success of a notation may be an ability to provide much information in an intuitive way without requiring excessive efforts from the users of the notation. The ConcurTaskTree may be able to support this as it has been demonstrated also by its use by people working in industries without a background in computer science.

The task model of the ConcurTaskTree category may include user tasks, application tasks, interaction tasks, and abstract tasks. User tasks may performed by the user (cognitive activities), e.g., making a decision, answering the telephone, and so on. Application tasks may be completely performed by the application, e.g., checking a login/password, giving an overview of documents, and so on. Interaction tasks may be performed by the user interacting with the system by some interaction technique, e.g., editing a picture, filling in a form, and so on. Abstract tasks may require complex activities, e.g., a user session with the system, and the like.

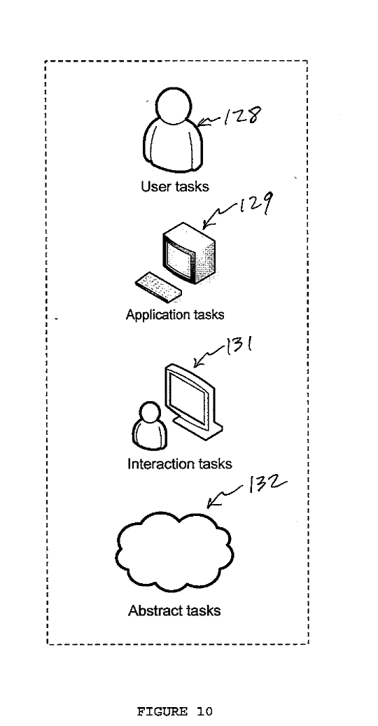

FIG. 10 shows a legend of CTT symbols or notation representing various tasks. Symbol 128 represents a user task; symbol 129 represents an application task; symbol 131 represents an interaction task; and symbol 132 represents an abstract task.

A set of ConcurTaskTree temporal operators may be shown as the following.

| | |
|---|---|
| Choice | T1 [ ] T2 |
| Concurrency | T1 \|\|\| T2 or T1 \|[ ]\| T2 |
| Disabling | T1 [> T2 |
| Interruption | T1 \|> T2 |
| Enabling | T1 >> T2 or T1 [ ]>> T2 |
| Iteration | T1* or T1{n} |
| Optionality | [T] |

The task model may involve a ConcurTaskTree enabled task set (ETS). A very important advantage of the CTT formalism may be a generation of enabled task sets (ETS) out of the specification. An ETS may be defined as a set of tasks that are logically enabled to start their performance during the same period of time. All tasks in an ETS may be presented together. The ETSs calculated from the model may include the following items.

ETS₁={Select Read SMS, Select, Shut Down}

ETS₂={Select SMS,Close, Shut Down}

ETS₃={Show SMS,Close, Shut Down}

ETS₄={Select,Close, Shut Down}

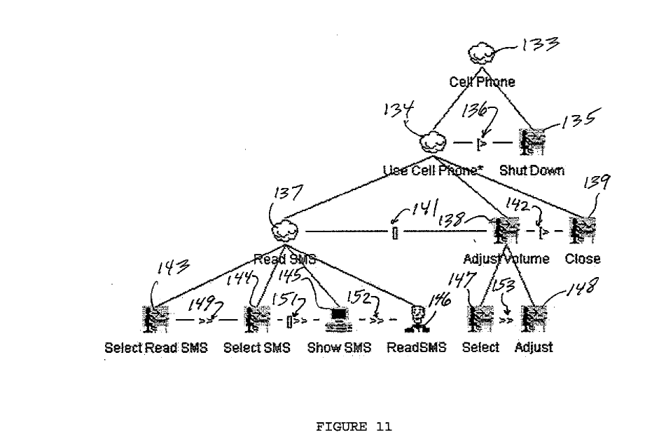

FIG. 11 shows a priority tree or CTT specification using some functionalities offered by a mobile or cell phone (SMS—short message service). The ETSs may be calculated by transforming the CTT specification into a priority tree and applying certain predefined rules. The cell phone 133 is represented by an abstract task symbol. This task 133 may branch out to a “use cell phone” abstract task 134 and a “shut down” interaction task 135. The temporal operator 136 between tasks 134 and 135 is a disabling operator [>. Task 134 may branch out to a “read SMS” abstract task 137, “adjust volume” interaction task 138, and “close” interaction task 139. Task 137 may be connected to task 138 with a choice [ ] temporal operator 141. Task 138 may be connected to task 139 with a disabling [> temporal operator 142. The task 137 may branch out to a “select read SMS” interaction task 143, a “select SMS” interaction task 144, a “show SMS” application task 145 and a “read SMS” user task 146. Task 138 may branch out to a “select” interaction task 147 and an “adjust” interaction task 148. Task 143 may be connected to task 144 with an enabling >> temporal operator 149. Task 144 may be connected to task 145 with a choice [ ] temporal operator 151. Task 145 may be connected to task 146 with an enabling >> temporal operator 152. Task 147 may be connected to task 148 with an enabling >> temporal operator 153.

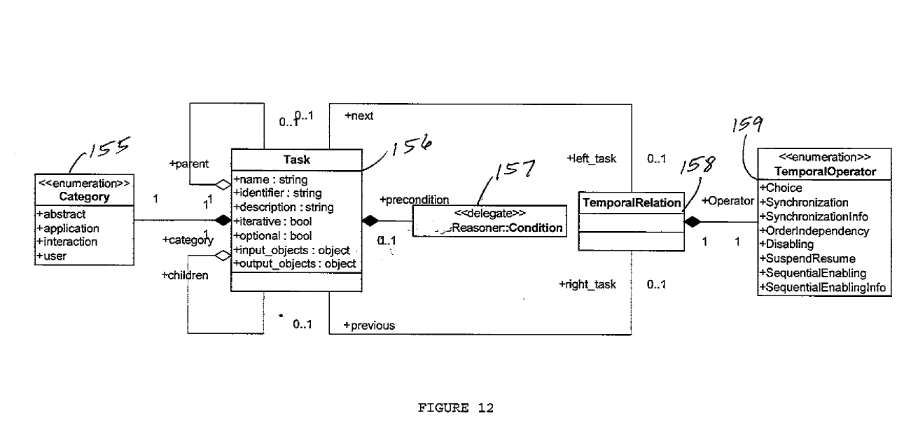

FIG. 12 shows a concurtasktree diagram. A category block 155 enumerating an abstract, application, interaction and/or user task is connected to a task block 156 listing a name, identifier, description, iterative, optional, input and output object tasks. A block 157 for a reasoner condition is connected to the task block 156. A temporal relation block 158 is connected to task block 156. A block 159 listing temporal operators is connected to the temporal relation block 158.

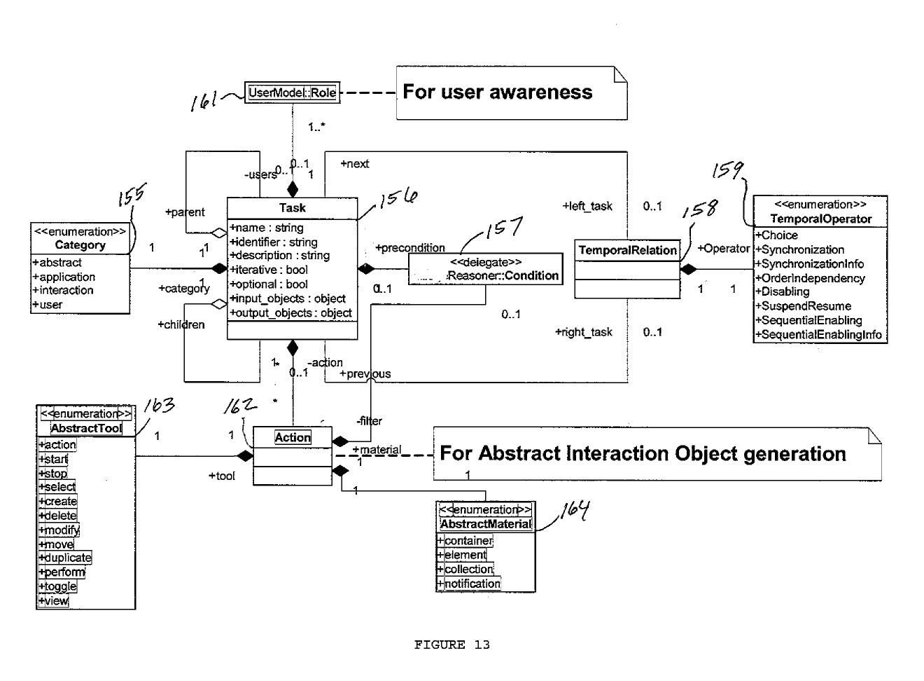

FIG. 13 shows an extension of the diagram of FIG. 12. A user model role block 161 for user awareness may be connected to the task block 156. An action block 162 for abstract interaction object generation may be connected to task block 156 and the reasoner block 157. An abstract tool block 163, for enumeration relative to action, start, stop, select, create, delete, modify, move, duplicate, perform, toggle and/or view, may be connected to block 162. An abstract material block 164, for enumeration of container, element, collection and/or notification, may be connected to block 162.

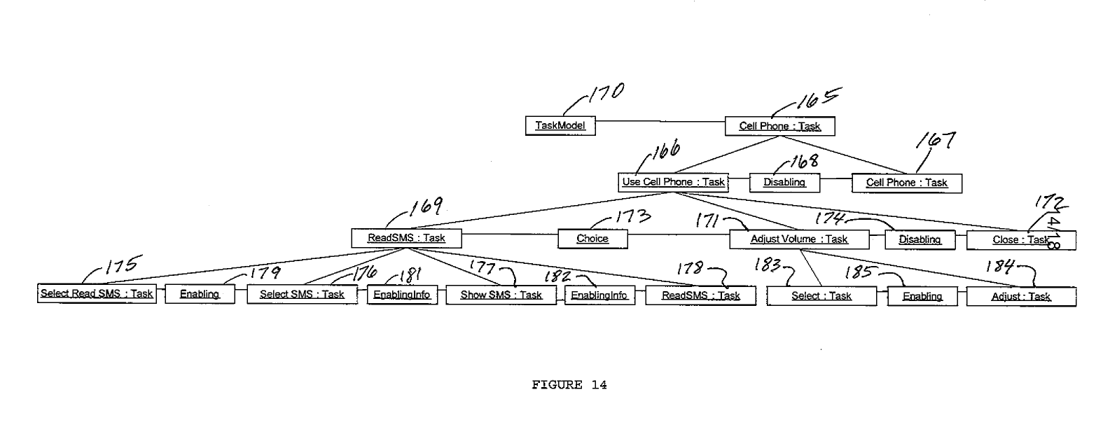

FIG. 14 is a concurtasktree class diagram related to a cell phone operation. A task model 170 is shown relative to a task block 165. The cell phone task block 165 may branch out to a “use cell phone task” block 166 and a “cell phone task” block 167. Task block 166 may be connected to task block 167 via a disabling block 168. Block 166 may branch out to a “read SMS task” block 169, an “adjust volume task” block 171 and a “close task” block 172. Block 169 may be connected to the block 171 via a choice block 173. Block 171 may be connected to block 172 via a disabling block 174. Block 169 may branch out to a “select read SMS task” block 175, a “select SMS task” block 176, a “show SMS task” block 177 and a “read SMS task” block 178. Block 175 may be connected to block 176 via an enabling block 179. Block 176 may be connected to block 177 via an enabling information block 181. Block 177 may be connected to block 178 via an enabling information block 182. The “adjust volume task” block 171 may branch out to a “select task” block 183 and an “adjust task” block 184. Block 183 may be connected to block 184 via an enabling block 185.

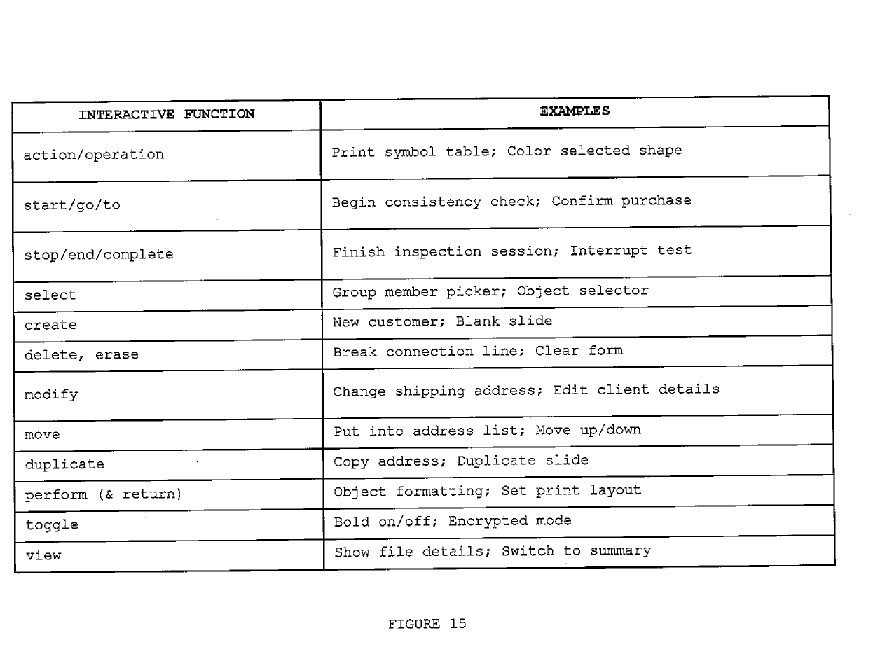

UI generation from a task model to AUI may involve using “canonical abstract components” to link the task model and the AUI. Interactive functions with examples are listed in a table of FIG. 15. Interactive function with examples may be listed in a format of “function—examples”: action/operation—print symbol table, color selected shape; start/go/to—begin consistency check, confirm purchase; stop/end/complete—finish inspection session, interrupt test; select—group member picker, object selector; create—new customer, blank slide; delete, erase—break connection line, clear form; modify—change shipping address, edit client details; move—put into address list, move up/down; duplicate—copy address, duplicate slide; perform(& return)—object formatting, set print layout; toggle—bold on/off, encrypted mode; and view—show file details, switch to summary.

From abstraction to realization, abstract prototypes may be based on canonical components. A powerful new form of abstract prototype is described that speeds and simplifies the transition from an abstract task model to a realistic paper prototype by using a standardized set of user interface abstractions. Such canonical components may specify function, size, and position in the emerging design but leave unspecified the appearance and detailed behavior. In this way, canonical prototypes may facilitate high-level design and architectural decision making without the burden of resolving or addressing numerous concrete details. Abstract prototypes based on canonical components may also promote design innovation and facilitate recognition of common user interface design patterns.

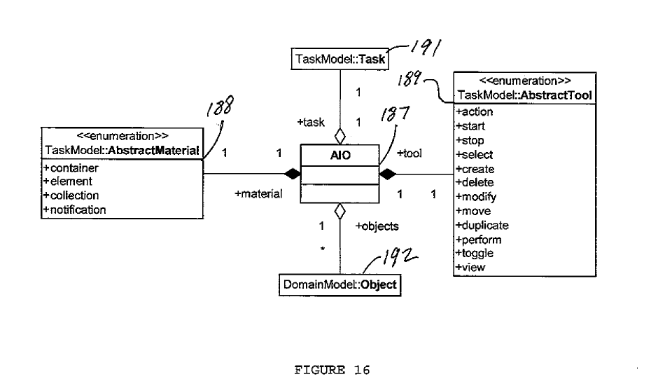

FIG. 16 is a diagram of an abstract interaction object (AIO) represented by a block 187. A block 188 which shows abstract material for a task model may be connected to block 187. Block 188 may enumerate a container, an element, a collection and/or a notification for block 187. A block 189 which shows abstract tools for a task model may be connected to block 187. Block 189 may enumerate an action, start, stop, select, create, delete, modify, move, duplicate, perform, toggle and/or view for block 187. A task model block 191 and a domain model object block 192 may be connected to the AIO block 187.

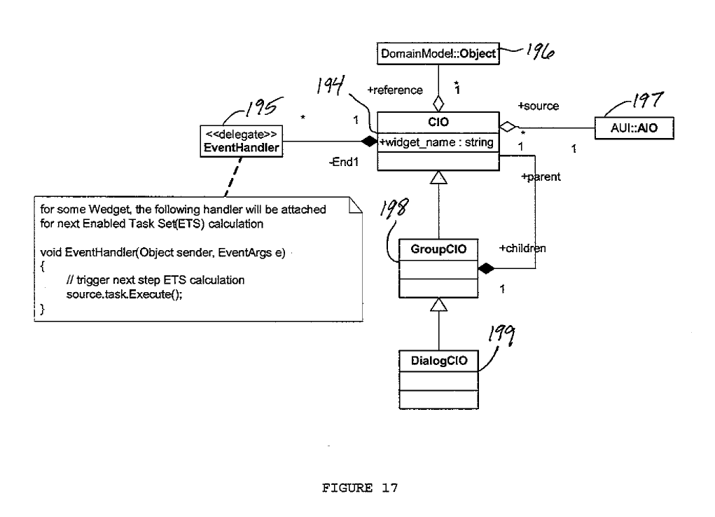

FIG. 17 is a diagram of a concrete interaction object (CIO) block 194 and associated blocks. An event handler block 195 and a domain model object block 196 may be connected to block 194. An abstract user interface—abstract interaction object block 197 may be connected to block 194. A group CIO block 198 may be connected to block 194. A dialog CIO block 199 may be connected to block 198. Relative to block 195, for some widget, the handler may be attached for a next enabled task set (ETS) calculation, which may be indicated by a following program line—void EventHandler(Object sender, EventArgs e) {// trigger next step ETS calculation source.taskExecute( );}.

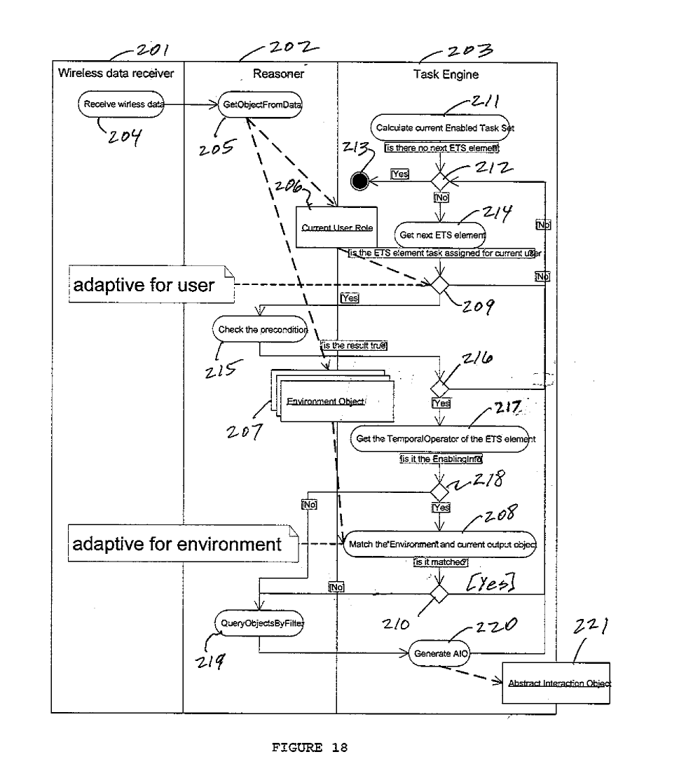

FIG. 18 is a diagram of an AUI generation algorithm mechanism. Major portions may consist of a wireless receiver 201, reasoner 205 and a task engine 203. Wireless data 204 may be received by receiver 201. Data may be provided to the get object from data block 205 of reasoner 202. An output from block 205 may go to a current user role block 206 and to an environment object multi-document block 207. An output from block 207 may go to a “match the environment and current output object” block 208 which is adaptive for an environment. An output from block 206 may go to a decision symbol 209 of task engine 203. Symbol 209 may be adaptive for a user.

A “calculate current enabled task set (ETS)” block 211 of task engine 203 may have an output to a decision symbol 212. Symbol 212 may ask whether there is no next ETS element. If the answer is yes, then the next step may be at terminal 213. If the answer is no, then a next ETS element may be obtained according to block 214. The output according to block 214 may go to a decision symbol 209 which asks the question whether the ETS element task is assigned for a current user. If the answer is no, then that indication is provided to and processed by the decision symbol 212. If the answer to the question of symbol 209 is yes, then the output may be “check the precondition” according to block 215 of reasoner 202, which goes to a decision symbol 216 of task engine 203, that asks whether the result is true. If the answer is no, then that indication is provided to and processed by the decision symbol 212. If the answer is yes, then an output may be get the temporal operator of the ETS element according to block 217. The step according to block 217 may go to a decision symbol 218 which asks whether it is the enabling information. If the answer is no, then a step “query objects by filter” according to block 219 of reasoner 202 may occur. The indication of block 219 may go to generate AIO block 220 with an output abstract interaction object as indicated by block 221 of task engine 203. Also, an indication of block 220 may go to the decision symbol 212 for processing. If the answer of symbol 218 is yes, then the response may go to block 208 and on to decision symbol 210. It may be noted that after block or step 208, optimized tasks/ETS may be obtained. If an answer from symbol 210 is no, then block 219 may be effected. If the response is yes, then a response may go to decision symbol 212.

UI generation may be from AUI to CUI (adaptive for a platform). CIOs may be extracted from AIO based on a domain object. Right widgets may be selected for CIOs based on a target widget library. Layout information may be calculated for current DialogCIO based on the current platform model. If a current DialogCIO can not be laid out, then a new DialogCIO may be generated with a navigation CIO, and Goto 3. Appropriate event handlers may be attached for certain CIOs. Then the first DialogCIO may be presented.

Other considerations may be noted. Models and the knowledge base may be enriched. Human factors may be integrated into some knowledge bases, such as UI patterns, design guidelines, and the like. Models and KBs may be improved to improve the quality of a generated UI. The interaction mode should be improved for better UI generation. An enabled task set (ETS) may be used to generate an AUI in a current stage. An integrated interaction design platform may be developed. A making of plug-ins may be considered for some platform framework, such as Protégé, Eclipse, VS.Net, and so forth. An autonomic UI may involve user behavior modeling and user intent reasoning.

Two parts of the present description may be noted. One is task optimization based on context information. The other is a model-based UI generation solution. The relationship between these two parts may be emphasized. After getting the optimized tasks, one may generate the final UI from them by the model-based solution.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A method of improving a user's interaction with a computer system, comprising:
providing a task;
introducing activation criteria based on contextual information; and
applying contextual information to the task at runtime.

2. The method of claim 1, further comprising applying the contextual information to optimize user interaction quality.

3. The method of claim 2, wherein a task is an application task.

4. The method of claim 3, wherein:
an application task is executed by a computer system; and
the application task receives information from the computer system and can provide information to the user.

5. The method of claim 2, wherein the task is an interaction task.

6. The method of claim 5, wherein the interaction task is performed with user interactions of a computer system.

7. The method of claim 1, wherein the task is provided from a hierarchical tree-like structure of tasks.

8. A mechanism for improving a user's interaction with a computing system, comprising:
a task module comprising:
a first rule base;
a second rule base; and
a context buffer connected to the first and second rule bases;
a context acquisition module connected to the context buffer; and
a user interaction input connected to the context buffer.

9. The mechanism of claim 8, wherein context is applied to a task at runtime.

10. The mechanism of claim 8, wherein the task module is connected to a concur task tree.

11. The mechanism of claim 8, wherein;
the first rule base is a task activation criteria rule base; and
the second rule base is an interaction quality optimizer rule base.

12. The mechanism of claim 11, wherein
context from an environment and/or information from the user interaction input via the context buffer is for the first rule base; and
the first rule base is for indicating if a task can be activated.

13. The mechanism of claim 12, wherein
content from the context buffer is for the second rule base; and
the second rule base is for improving the user interaction input.

14. The mechanism of claim 13, wherein the task is an application task or an interaction task.

15. The mechanism of claim 14, wherein:
the application task is executed by the computing system; and
the interaction task is performed by a user of the computing system.

16. A method for executing a task comprising:
determining a task to be computable;
enabling a context buffer of the task;
asserting content of the context buffer into a first rule base of the task;
determining whether the task can be activated according to the first rule base;
asserting content of the context buffer into a second rule base, if the task can be activated;
determining whether a rule is activated in the second rule base; and
pursuing an enabled task set computing for the task, if a rule is not activated in the second rule base.

17. The method of claim 16, further comprising:
determining whether the task is an interaction task if the task can be activated;
determining whether the task has a temporal relationship that is enabling with information, if the task is an interaction task; and
asserting content of the context buffer into a second rule base, if the task has the temporal relation that is enabling with information.

18. The method of claim 16, wherein:
the first rule base is a task activation criteria rule base; and
the second rule base is an interaction quality optimization rule base.

19. The method of claim 18, wherein:
a design of activation rules for the task activation criteria rule base, is dependent on a definition of the task; and
a design of interaction quality optimization rules for the interaction quality optimization rule base, is dependent on generation of a user interface.

20. The method of claim 16, wherein the task is of a hierarchical tree-like structure of tasks.
